(19) United States
(12) Patent Application Publication
(10) Pub. No.: US 2017/0341909 A1
(43) Pub. Date: Nov. 30, 2017

(54) HOISTWAY LANDING DOOR LOCKING SYSTEM AND METHOD OF CONTROLLING ACCESS TO AN ELEVATOR SHAFT

(71) Applicants: Nicolas FONTENEAU, Gien (FR); Otis Elevator Company, Farmington, CT (US)

(72) Inventors: Nicolas Fonteneau, Vitry Aux Loges (FR); Gerard Sirigu, Gien (FR)

(21) Appl. No.: 15/534,870

(22) PCT Filed: Dec. 12, 2014
(86) PCT No.: PCT/IB2014/002949

§ 371 Date: Jun. 9, 2017

(51) Int. Cl. B66B 13/14; E05B 47/00; E05B 35/12; E05B 47/06

(52) U.S. Cl. CPC B66B 13/14; E05B 47/06; E05B 47/0002; E05B 35/12; E05B 2047/0085; E05Y 2900/104

(57) ABSTRACT

A hoistway landing door locking system includes an elevator shaft and an elevator car disposed within the elevator shaft and moveable therein between a plurality of access openings located at a plurality of levels of the elevator shaft. Also included is a mechanical locking assembly disposed proximate at least one of the access openings, the mechanical locking assembly operable to switch the access opening between a locked condition and an unlocked condition. Further included is an electromagnetic locking assembly operable between an energized condition and an unenergized condition, wherein the energized condition is required to switch the mechanical locking assembly from the locked condition to the unlocked condition.

### BACKGROUND OF THE INVENTION

The subject matter disclosed herein relates to elevator systems and, more particularly, to a hoistway landing door locking system for use with elevator systems, as well as a method of controlling access to an elevator shaft.

Elevators with a shallow pit and/or a low overhead are advantageous because of the reduced impact of their installation on the construction cost and because of the compatibility with severe architectural constraints. These designs, however, result in mechanics being tasked with going to the top of the car, or into the pit for inspection or maintenance activities. In addition to authorized access, unauthorized access into the elevator shaft may also occur. As such, certain regulatory measures, particularly in Europe, have been proposed and/or enacted that will require larger spaces at the top of the elevator shaft and within the pit. This required additional space is undesirable from a construction and architectural standpoint.

Based on the considerations discussed above, elevator designers are seeking solutions to prevent and to control elevator shaft access, especially for non-authorized individuals. The access control must be achieved in a robust manner if small elevator shaft dimensions are to be proposed. One access control method is to provide locking assemblies on landing doors. For example, a key may be required to unlock a landing door, but this leaves open the undesirable possibility that any individual possessing the key may be able to unlock the landing door and enter the elevator shaft.

### BRIEF DESCRIPTION OF THE INVENTION

According to one aspect of the invention, a hoistway landing door locking system includes an elevator shaft and an elevator car disposed within the elevator shaft and moveable therein between a plurality of access openings located at a plurality of levels of the elevator shaft. Also included is a mechanical locking assembly disposed proximate at least one of the access openings, the mechanical locking assembly operable to switch the access opening between a locked condition and an unlocked condition. Further included is an electromagnetic locking assembly operable between an energized condition and an unenergized condition, wherein the energized condition is required to switch the mechanical locking assembly from the locked condition to the unlocked condition.

In addition to one or more of the features described above, or as an alternative, further embodiments may include a mechanical locking assembly at each of the access openings.

In addition to one or more of the features described above, or as an alternative, further embodiments may include that the mechanical locking assembly comprises a key and a clutch assembly.

In addition to one or more of the features described above, or as an alternative, further embodiments may include that the electromagnetic locking assembly includes a control panel for inputting a command and an electromagnetic device located proximate the mechanical locking assembly.

In addition to one or more of the features described above, or as an alternative, further embodiments may include that the clutch assembly comprises a first clutch element and a second clutch element, wherein the second clutch element includes a through hole having a locking arm disposed therein.

In addition to one or more of the features described above, or as an alternative, further embodiments may include that rotation of the locking arm switches the mechanical locking assembly between the locked condition and the unlocked condition.

In addition to one or more of the features described above, or as an alternative, further embodiments may include that the electromagnetic device moves the second clutch element into engagement with the first clutch element during the energized condition of the electromagnetic locking assembly.

In addition to one or more of the features described above, or as an alternative, further embodiments may include that the electromagnetic device comprises a solenoid.

In addition to one or more of the features described above, or as an alternative, further embodiments may include that engagement of the first clutch element and the second clutch element is required for rotation of the locking arm to switch the mechanical locking assembly from the locked condition to the unlocked condition.

In addition to one or more of the features described above, or as an alternative, further embodiments may include a spring operatively coupled to the locking arm to maintain an axial position of the locking arm.

In addition to one or more of the features described above, or as an alternative, further embodiments may include that the control panel is located at the same level of the elevator shaft as the location of the mechanical locking assembly that it controls.

In addition to one or more of the features described above, or as an alternative, further embodiments may include a single control panel that controls a plurality of mechanical locking assemblies at a plurality of levels of the elevator shaft.

According to another aspect of the invention, a method of controlling access to an elevator shaft is provided. The method includes maintaining a landing door at an access opening of an elevator shaft in a locked condition with a mechanical locking assembly and an electromagnetic locking assembly. The method also includes energizing the electromagnetic locking assembly into an energized condition. The method further includes manually switching the landing door to an unlocked condition with the mechanical locking assembly only during the energized condition of the electromagnetic locking assembly.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an elevator assembly having a landing door locking system;

FIG. 2 is a perspective view of one level of the elevator assembly having an access opening and generally illustrating the landing door locking system;

FIG. 3 is a sectional view of the landing door locking system in a locked condition; and

FIG. 4 is a sectional view of the landing door locking system in an unlocked condition.

The detailed description explains embodiments of the invention, together with advantages and features, by way of example with reference to the drawings.

### DETAILED DESCRIPTION OF THE INVENTION

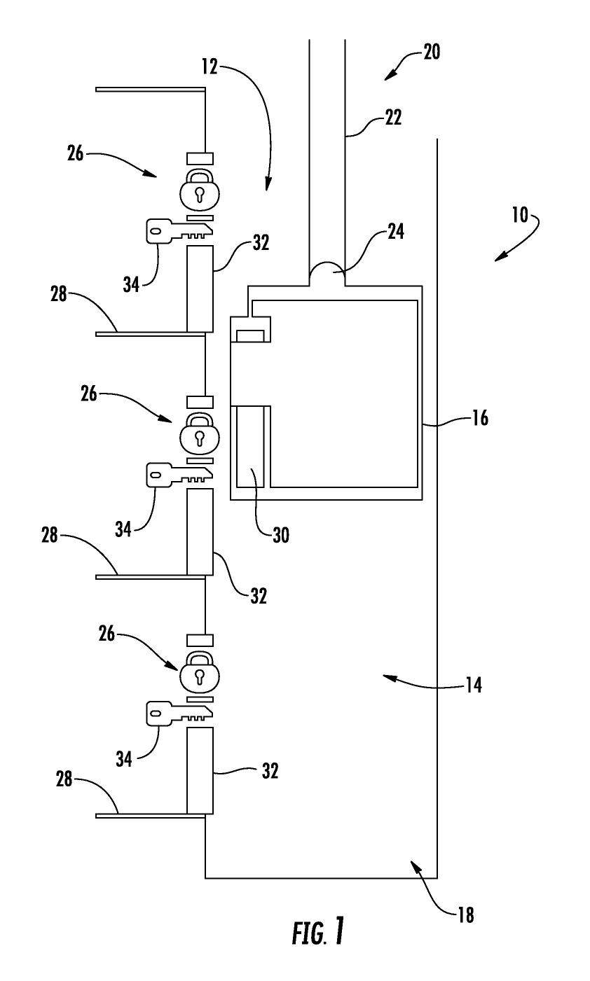

Referring to FIG. 1, an elevator assembly is illustrated and generally referenced with numeral 10. The embodiments described herein relate to a landing door locking system 12 and a method that facilitates control of access to an elevator shaft 14 (which may also be referred to as a hoistway) of the elevator assembly 10, as will be described in detail below. The elevator assembly 10 includes an elevator car 16 (which may also be referred to as a lift car) that moves along guide rails in a known manner. The elevator car 16 is disposed within the elevator shaft 14 and is moveable therein, typically in a vertical manner. In one embodiment, the elevator car 16 essentially moves along the entire length of the elevator shaft 14 between a lower end 18 (i.e., a pit) and an upper end 20. A drive system (not illustrated) includes a motor and brake and is conventionally used to control the vertical movements of the elevator car 16 along the elevator shaft 14 via a traction system (partially illustrated) that includes cables, belts or the like 22 and at least one pulley 24. It should be readily appreciated as well that, although the elevator assembly 10 is disclosed herein as including a pulley 24, the elevator assembly 10 can be implemented with other drive systems, such as a linear motor-driven elevator (e.g., a ropeless, self-propelled elevator).

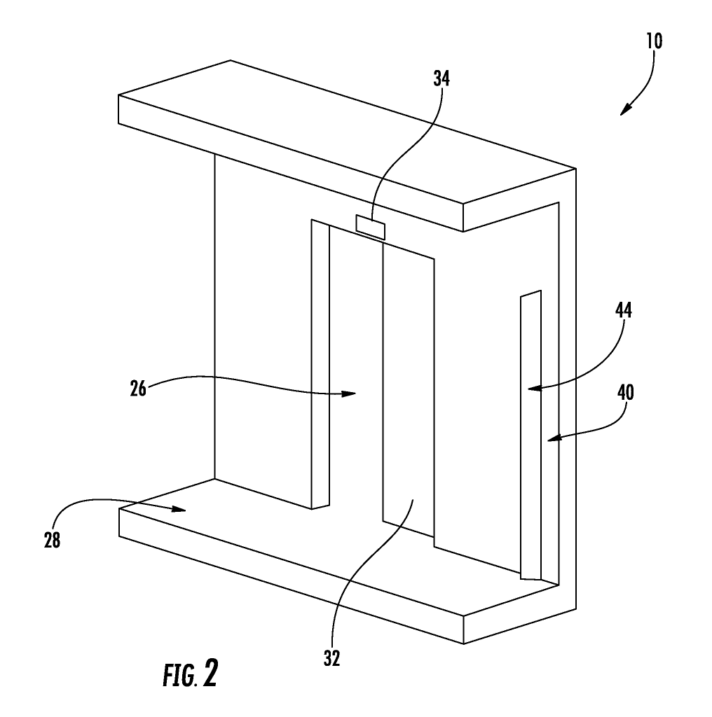

As described above, the elevator car 16 moves within the elevator shaft 14 between the lower end 18 and the upper end 20. More specifically, the elevator car 16 is configured to stop therebetween at a plurality of access openings 26 located at a plurality of levels 28 of the elevator shaft 14. The elevator car 16 includes an elevator door 30 and each of the access openings 26 includes a landing door 32. Upon alignment of the elevator door 30 and one of the landing doors 32, both doors may be opened to allow entrance or exit to the elevator car 16 for people and/or cargo. FIG. 2 illustrates a single level of the overall elevator assembly 10 to show a single access opening 26 that the landing door locking system 12 is employed with.

In order to prevent access to the elevator shaft in situations other than the above-described scenario (i.e., alignment of elevator door 30 and landing door 32), the landing door locking system 12 is provided to limit access to loading and unloading of the elevator car 16 or to permit access to the elevator shaft 14 by authorized personnel. The landing door locking system 12 includes a mechanical locking assembly 34 located on at least one, but up to all of the plurality of access openings, to thereby control functionality of the landing doors 32. More specifically, each mechanical locking assembly 34 at each level 28 of the elevator shaft 14 is operable between a locked condition and an unlocked condition. The locked condition corresponds to a locked state of the respective landing door 32 that the particular mechanical locking assembly 34 is associated with. Similarly, the unlocked condition corresponds to an unlocked state of the respective landing door 32 that the particular mechanical locking mechanism 34 is associated with.

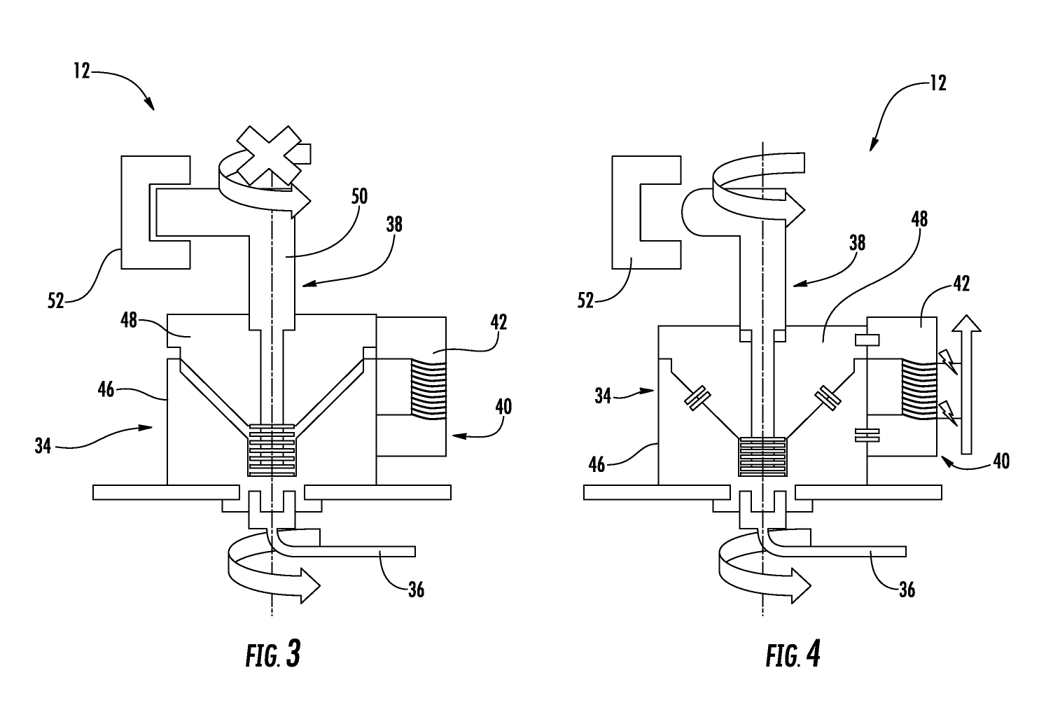

Referring to FIGS. 3 and 4, the mechanical locking assembly 34 is any type of mechanical assembly or component that facilitates manually switching between the unlocked and locked conditions of the landing door 32. For example, a key 36 and associated locking device 38 may be employed as the mechanical locking assembly 34. In one embodiment, elevator systems employ a triangular key that is used to manually unlock the landing door 32.

The landing door locking system 12 limits access to the elevator shaft 14 to situations where the elevator door 30 and one of the landing doors 32 are in alignment or to permit access to authorized individuals, as noted above. To achieve this technical effect, an action in addition to manual use of the key 36 with the mechanical locking assembly 34 is required for switching from a locked condition (FIG. 3) of the landing door locking system 12 to an unlocked condition (FIG. 4). In particular, an electromagnetic locking assembly 40 is provided as a secondary feature that is required to unlock the landing door 32. This additional layer of security prevents unlocking of the door by an individual who is simply in possession of a key or the like to manipulate the mechanical locking assembly 34.

The electromagnetic locking assembly 40 includes any electromagnetic device(s) 42 that is/are operable between an energized condition and an unenergized condition. An authorized individual is able to provide an input into a control panel 44 (FIG. 2) or the like to switch the electromagnetic device 42 into the energized condition. The control panel 44 or a similar system is configured to receive an input and transmit the signal to the electromagnetic device 42 in a wired or wireless manner to energize the device. The input may be a code entered on a keypad, a biometric sensor to detect a unique identifier, waving of a key fob, etc. These are just illustrative examples of secure ways in which the input may be provided to switch the electromagnetic device 42 into the energized condition. It is to be appreciated that the control panel 44 or similar system may be provided at each level that includes a mechanical locking assembly or may be located at different levels. Instead, a single control panel 44 may also be located in a remote location to control the electromagnetic device(s) 42 at each of the landing doors 32.

Regardless of the precise manner in which the input is provided to energize the electromagnetic device 42, upon proper input a voltage energizes the device 42 by providing a current to the device. In one embodiment, the electromagnetic device 42 is a solenoid. The electromagnetic device 42 is located in close proximity to the mechanical locking assembly 34. In one embodiment, the associated locking device 38 of the mechanical locking assembly 34 comprises a clutch assembly that includes a first clutch element 46 and a second clutch element 48. The second clutch element 48 is in operative engagement with a locking arm 50 that interacts with a locking structure 52. The operative engagement of the second clutch element 48 and the locking arm 50 is facilitated by a through hole defined by the second clutch element 48 that the locking arm 50 resides within. The locking arm 50 may be fit therein to rotate with the second clutch element 48 due to friction and/or mechanical fastener engagement. Rotation of the locking arm 50 is required to disengage the locking arm 50 from the locking structure 52 in order to switch the mechanical locking assembly 34 to the unlocked condition.

As shown in the locked condition of FIG. 3, the locking arm 50 is unable to rotate when the first clutch element 46 and the second clutch element 48 are not engaged. In this condition, the key 36 will rotate the first clutch element 46, but this will not impart rotation of the second clutch element 48 and the key due to a lack of engagement of the first and second clutch elements 46, 48.

Upon switching the electromagnetic device 42 to the energized condition, the second clutch element 48 is moved to engage the first clutch element 46 due to the magnetic field that is generated upon energizing the electromagnetic device 42. This engagement allows rotation of the second clutch element 48 and the locking arm 50 to switch the mechanical locking assembly 34 to the unlocked condition illustrated in FIG. 4. To maintain the axial position of the locking arm 50, a spring or other biasing member is provided and is operatively coupled to the locking arm 50.

Advantageously, the energized condition is required to switch the mechanical locking assembly 34 from the locked condition (FIG. 3) to the unlocked condition (FIG. 4). As described in detail above, the energized condition is only achieved by a predetermined input by an authorized individual, thereby ensuring that access to the elevator shaft 14 is securely controlled. The landing door locking system 12 prevents individuals from being on top of the elevator car 16 or in the pit of the elevator shaft 14. This system and method allows regions of the elevator shaft 14 to be reduced in volume, which is desirable for architectural and construction purposes.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A hoistway landing door locking system comprising:
an elevator shaft;
an elevator car disposed within the elevator shaft and moveable therein between a plurality of access openings located at a plurality of levels of the elevator shaft;
a mechanical locking assembly disposed proximate at least one of the access openings, the mechanical locking assembly operable to switch the access opening between a locked condition and an unlocked condition; and
an electromagnetic locking assembly operable between an energized condition and an unenergized condition, wherein the energized condition is required to switch the mechanical locking assembly from the locked condition to the unlocked condition.

2. The hoistway landing door locking system of claim 1, further comprising a mechanical locking assembly at each of the access openings.

3. The hoistway landing door locking system of claim 1, wherein the mechanical locking assembly comprises a key and a clutch assembly.

4. The hoistway landing door locking system of claim 1, wherein the electromagnetic locking assembly comprises:
a control panel for inputting a command; and
an electromagnetic device located proximate the mechanical locking assembly.

5. The hoistway landing door locking system of claim 2, wherein the clutch assembly comprises a first clutch element and a second clutch element, wherein the second clutch element includes a through hole having a locking arm disposed therein.

6. The hoistway landing door locking system of claim 5, wherein rotation of the locking arm switches the mechanical locking assembly between the locked condition to the unlocked condition.

7. The hoistway landing door locking system of claim 4, wherein the electromagnetic device moves the second clutch element into engagement with the first clutch element during the energized condition of the electromagnetic locking assembly.

8. The hoistway landing door locking system of claim 4, wherein the electromagnetic device comprises a solenoid.

9. The hoistway landing door locking system of claim 7, wherein engagement of the first clutch element and the second clutch element is required for rotation of the locking arm to switch the mechanical locking assembly from the locked condition to the unlocked condition.

10. The hoistway landing door locking system of claim 5, further comprising a spring operatively coupled to the locking arm to maintain an axial position of the locking arm.

11. The hoistway landing door locking system of claim 4, wherein the control panel is located at the same level of the elevator shaft as the location of the mechanical locking assembly that it controls.

12. The hoistway landing door locking system of claim 4, wherein the control panel is located at a different level of the elevator shaft as the location of the mechanical locking assembly that it controls.

13. A method of controlling access to an elevator shaft comprising:
maintaining a landing door at an access opening of an elevator shaft in a locked condition with a mechanical locking assembly and an electromagnetic locking assembly;
energizing the electromagnetic locking assembly into an energized condition; and
manually switching the landing door to an unlocked condition with the mechanical locking assembly only during the energized condition of the electromagnetic locking assembly.
